(19) United States
(12) Patent Application Publication
(10) Pub. No.: US 2002/0084438 A1
(43) Pub. Date: Jul. 4, 2002

(54) Hygroscopic composition, hygroscopic agent, and production process therefor

(76) Inventors: Kazuhiro Okamura, Sanda-shi (JP); Yoshihiko Masuda, Takarazuka-shi (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 09/986,443

(22) Filed: Nov. 8, 2001

(30) Foreign Application Priority Data
Nov. 14, 2000 (JP) 2000-347123

(51) Int. Cl. H01G 2/00

(52) U.S. Cl. 252/62.2

(57) ABSTRACT

The present invention provides: a hygroscopic composition, which comprises a combination of a deliquescent substance having excellent capacity for absorbing moisture and a liquid-absorbent resin highly absorbing and retaining the resultant deliquescence from the deliquescent, and can highly absorb and retain the resultant deliquescence from the deliquescent without liquefaction when absorbing moisture; a hygroscopic agent, which is a preferred mode for use; and a production process therefor. The hygroscopic composition comprises a liquid-absorbent resin and a solid deliquescent substance, wherein the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C. In addition, one of the hygroscopic agents comprises a liquid-absorbent resin and a solid deliquescent substance, wherein: the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C., and is blended with the solid deliquescent substance; and the resultant mixture is wrapped with a wrapping film of which at least a portion comprises a humidity-permeable film.

### BACKGROUND OF THE INVENTION

A. Technical Field

The present invention relates to a hygroscopic composition, a hygroscopic agent, and a production process for a hygroscopic agent.

B. Background Art

Deliquescent substances, such as calcium chloride and magnesium chloride, are utilized for their excellent dehumidifying capacity, and used for various uses, such as dehumidifying agents, dew inhibitors, drying agents, or humidity-adjusting agents. However, when calcium chloride and magnesium chloride absorb moisture and deliquesce, they liquefy. Therefore, there were problems such that the resultant deliquescence leaks and contaminates surroundings when a vessel was broken.

Accordingly, means for inhibiting the leak by making the deliquescence sticky, or absorbing and gelling the deliquescence have been considered. Examples thereof are disclosed as follow: (1) a method for inhibiting liquefaction, which involves adding water-soluble polymers, such as poly(vinyl alcohol), poly(sodium acrylate), and poly(acrylamide), in order to make the deliquescence sticky (JP-A-107042/1977, JP-A-143819/1985, and JP-A-252524/1988); and (2) a method for inhibiting liquefaction, which involves adding water-absorbent resins, such as water-absorbent modified polyethylene oxide resins, crosslinked α-starchs, cationic water-absorbent resins, and crosslinked polymers of acrylamide and acrylic acid (salt), and absorbing and gelling the deliquescence (JP-A-200835/1986, JP-A-31522/1988, JP-A-127610/1991, JP-A-78415/1992, and JP-A-221428/1999).

As is mentioned in the above way, known is the method that involves using the water-soluble polymers or the water-absorbent resins as the means for inhibiting from leaking the deliquescence.

However, when the water-soluble polymers are used for inhibiting the liquefaction, the adhesion or cohesion is caused, and the liquefaction of the deliquescent substance cannot be inhibited. Therefore, there was a possibility that both might liquefy.

On the other hand, when the water-absorbent resins are used for inhibiting the liquefaction, there were problems in the following.

Water-absorbent resins are classified broadly into the following three kinds of types: an anionic-group-containing type, a cationic-group-containing type, and an nonionic-group-containing type.

When the anionic-group-containing or cationic-group-containing water-absorbent resin as used for diapers is utilized, its absorption capacity is low or becomes decreased. Therefore, there was a possibility that the resultant aqueous solution including concentrated electrolytes, such as deliquescing calcium chloride, could not be absorbed or retained enough. The cause is assumed that the absorption capacity of the anionic-group-containing or cationic-group-containing water-absorbent resin depends upon its osmotic pressure. That is to say, when the salt (ion) concentration of the liquid is higher, the salt (ion) concentration difference (osmotic pressure difference) in the water-absorbent resin is lost, and the absorption capacity is decreased. Especially, the deliquescence of such as calcium chloride is almost an aqueous saturated solution. Therefore, these water-absorbent resins do not absorb the liquid at all.

When the nonionic-group-containing water-absorbent resin is utilized, the resin can absorb more aqueous concentrated electrolyte solution than the anionic-group-containing or cationic-group-containing water-absorbent resin. Therefore, the consideration of the resin is variously carried out. However, its absorption capacity is insufficient, and it is expected to further improve the resin.

The absorption capacity of the nonionic-group-containing water-absorbent resin is due to affinity between the nonionic hydrophilic group and the aqueous solution, and believed not to be influenced by the kind or concentration of the electrolytes in comparison with the anionic-group-containing or cationic-group-containing water-absorbent resin. However, among (co)polymers of various nonionic-group-containing monomers, the following polymer has not been found yet: the polymer which can absorb as large a quantity of an aqueous saturated electrolyte solution, such as an aqueous saturated calcium chloride solution, as 20 times or more. As one of the examples, a crosslinked product of polyethylene oxide, N-vinylacetoamide polymer, or acrylamide polymer is shown in the comparative example. In addition, there is little knowledge about the absorption capacity in the area of saturated concentration of the water-absorbent resin.

### SUMMARY OF THE INVENTION

A. Object of the Invention

Accordingly, an object of the present invention is to provide: a hygroscopic composition, which comprises a combination of a deliquescent substance having excellent capacity for absorbing moisture and a liquid-absorbent resin highly absorbing and retaining the resultant deliquescence from the deliquescent, and can highly absorb and retain the resultant deliquescence from the deliquescent without liquefaction when absorbing moisture; a hygroscopic agent, which is a preferred mode for use; and a production process therefor.

B. Disclosure of the Invention

The present inventors diligently studied the above-mentioned problems. As a result, they found that: a crosslinked polymer, obtained by polymerizing a monomer component comprising a major proportion of a cyclic N-vinyllactam, can highly absorb and retain an aqueous concentrated multivalent metal salt solution, such as an aqueous saturated calcium chloride solution.

From the above findings, the above-mentioned objects are accomplished by using a liquid-absorbent resin as a means for inhibiting the leak of deliquescence, which is a crosslinked polymer obtained by polymerizing a monomer component comprising a major proportion of a cyclic N-vinyllactam and displays an absorption capacity of not less than 20 g/g for an aqueous saturated calcium chloride solution at 25° C., and by combining this liquid-absorbent resin with a solid deliquescent substance. In addition, the objects are accomplished by blending the above specific liquid-absorbent resin with a solid deliquescent substance, and by wrapping the resultant mixture with a wrapping film of which at least a portion comprises a humidity-permeable film. Furthermore, the objects are accomplished by arranging the above specific liquid-absorbent resin and a solid deliquescent substance so that when the solid deliquescent substance has absorbed moisture and deliquesced to liquefy, the resultant liquid can come into contact with the liquid-absorbent resin.

That is to say, a hygroscopic composition, according to the present invention, comprises a liquid-absorbent resin and a solid deliquescent substance, wherein the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

In addition, a hygroscopic agent, according to the present invention, comprises a liquid-absorbent resin and a solid deliquescent substance, wherein:

the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C., and is blended with the solid deliquescent substance; and the resultant mixture is wrapped with a wrapping film of which at least a portion comprises a humidity-permeable film.

In addition, a production process for a hygroscopic agent comprising a liquid-absorbent resin and a solid deliquescent substance, according to the present invention, comprises the steps of: blending the liquid-absorbent resin and the solid deliquescent substance; and wrapping the resultant mixture with a wrapping film of which at least a portion comprises a humidity-permeable film, wherein: the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

In addition, a hygroscopic agent, according to the present invention, comprises a liquid-absorbent resin and a solid deliquescent substance, wherein:

the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.; and the solid deliquescent substance is arranged so that when the solid deliquescent substance has absorbed moisture and deliquesced to liquefy, the resultant liquid can come into contact with the liquid-absorbent resin.

In addition, a production process for a hygroscopic agent comprising a liquid-absorbent resin and a solid deliquescent substance, according to the present invention, comprises the step of: arranging the solid deliquescent substance so that when the solid deliquescent substance has absorbed moisture and deliquesced to liquefy, the resultant liquid can come into contact with the liquid-absorbent resin, wherein: the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

These and other objects and the advantages of the present invention will be more fully apparent from the following detailed disclosure.

### BRIEF DESCRIPTION OF THE DRAWINGS

FIG. 1 is a figure that represents the evaluation method 1 of hygroscopic state.

FIG. 2 is a figure that represents the evaluation method 2 of hygroscopic state.

FIG. 3 is a figure of polygonal line graph represents absorption capacity of each liquid-absorbent resin when the concentration of the aqueous calcium chloride solution (weight %) and the absorption capacity (g/g) are plotted on X- and Y-axes respectively, and the concentration of the aqueous calcium chloride solution varies.

FIG. 4 is a figure that represents the present invention production process for a hygroscopic agent, comprising the steps of: blending a solid deliquescent substance with a liquid-absorbent resin, and wrapping the resultant hygroscopic composition with a humidity-permeable film.

FIG. 5 is a figure that represents the present invention production process for a hygroscopic agent, comprising the step of: arranging a solid deliquescent substance and a liquid-absorbent resin with a plate having openings so that when the solid deliquescent substance has absorbed moisture and deliquesced to liquefy, the resultant liquid can come into contact with the liquid-absorbent resin.

### DETAILED DESCRIPTION OF THE INVENTION

Various solid deliquescent substances are used in the present invention. However, examples thereof include: lithium chloride, sodium chloride, potassium chloride, calcium chloride, magnesium chloride, manganese sulfate, magnesium sulfate, lithium bromide, sodium bromide, potassium bromide, calcium bromide, magnesium bromide, sodium hydroxide, potassium hydroxide, and calcium hydroxide. Among these, lithium chloride, calcium chloride, and magnesium chloride are preferable.

The combining or using ratio of the solid deliquescent substance and the liquid-absorbent resin which is a crosslinked (co)polymer obtained by polymerizing a monomer component comprising a major proportion of a cyclic N-vinyllactam, and displays an absorption capacity of not less than 20 g/g for an aqueous saturated calcium chloride solution at 25° C., may fitly be determined in consideration of the absorption capacity of the liquid-absorbent resin, the kind of the deliquescent substance, and the condition of the atmosphere where the deliquescent substance is used.

For example, in case: anhydrous calcium chloride and a resin displaying an absorption capacity of 30 g/g for an aqueous saturated calcium chloride solution are respectively used as the solid deliquescent substance and the liquid-absorbent resin; and when the anhydrous calcium chloride deliquesces by absorbing moisture under a condition of the atmosphere where the deliquescent substance is used, the concentration of the resultant deliquescence is 45 weight %, and when the deliquescent substance is used and combined with the liquid-absorbent resin in a ratio of 13.5 parts by weight of the deliquescent substance per 1 part by weight of the liquid-absorbent resin, there are advantages in that the absorption capacity of the liquid-absorbent resin is sufficiently displayed. That is to say, there are advantages in comprising the solid deliquescent substance in an amount of not larger than the amount calculated by the following equation (1) per 1 part by weight of the liquid-absorbent resin.

Weight of deliquescent substance (part by weight)=Concentration of deliquescent substance in deliquescence (weight %)×Absorption capacity of liquid-absorbent resin (g/g) Equation (1)

The liquid-absorbent resin as used in the present invention is required to be a crosslinked (co)polymer obtained by polymerizing a monomer component comprising a major proportion of a cyclic N-vinyllactam.

The ratio of the cyclic N-vinyllactam in the entirety of the monomers (except for crosslinkable monomers) used for producing the crosslinked (co)polymer is not less than 80 mol %, preferably not less than 90 mol %, more preferably not less than 100 mol %. In case where the ratio of the cyclic N-vinyllactam is less than 80 mol %, the salt resistance, namely the absorption capacity for an aqueous concentrated multivalent metal salt solution is decreased.

Examples of the cyclic N-vinyllactam as used in the present invention include N-vinyl-2-pyrrolidone and N-vinylcaprolactam, but the cyclic N-vinyllactam is not especially limited thereto. These cyclic N-vinyllactams may be used either alone respectively or in combinations with each other. Among these, N-vinyl-2-pyrrolidone is particularly preferable in view of safety of the monomer and the resultant liquid-absorbent resin.

If monomers copolymerizable with the cyclic N-vinyllactam are unsaturated monomers compatible and copolymerizable with the cyclic N-vinyllactam, they can be used without limitation. Examples of the unsaturated monomers include: acrylic acid, methacrylic acid, itaconic acid, maleic acid, fumaric acid, crotonic acid, citraconic acid, vinylsulfonic acid, (meth)allylsulfonic acid, 2-(meth)acrylamido-2-methylpropanesulfonic acid, 2-(meth)acryloylethanesulfonic acid, 2-(meth)acryloylpropanesulfonic acid, and alkali metal salts or ammonium salts thereof; (meth)acrylamides, such as N,N-dimethylaminoethyl (meth)acrylate, and quaternary salts thereof; (meth)acrylamide, N,N-dimethyl(meth)acrylamide, 2-hydroxyethyl(meth)acrylamide, diacetone (meth)acrylamide, N-isopropyl(meth)acrylamide, and (meth)acryloylmorpholine, and derivatives thereof; hydroxyalkyl (meth)acrylates, such as 2-hydroxyethyl (meth)acrylate and 2-hydroxypropyl (meth)acrylate; polyalkylene glycol mono(meth)acrylate, such as polyethylene glycol mono(meth)acrylate, polypropylene glycol mono(meth)acrylate, methoxypolyethylene glycol mono(meth)acrylate, and methoxypolypropylene glycol mono(meth)acrylate; N-vinyl monomers, such as N-vinylsuccinimide; N-vinylamides, such as N-vinylformamide, N-vinyl-N-methylformamide, N-vinylacetamide, and N-vinyl-N-methylacetamide; and vinyl methyl ether. However, the unsaturated monomers are not especially limited thereto. These ethylenically unsaturated monomers may be used either alone respectively or in combinations with each other.

As to methods for obtaining the crosslinked (co)polymers, the following various methods can be employed: bulk polymerization method, solution polymerization method, emulsion polymerization, suspension polymerization method, and precipitation polymerization method. The concentration of the monomer component in an aqueous solution prepared in the former step is not less than 25 weight %, preferably in the range of 25 to 80 weight %.

In case where the concentration of the monomer component is less than 25 weight %, crosslinked liquid-absorbent resins may not be obtained, and the resultant resins may be dissolved in such as water. In addition, when crosslinked liquid-absorbent resins are obtained, it is difficult to pulverize gels obtained after the polymerization. In addition, it takes much time to dry the gels and the resins may be deteriorated while drying. On the other hand, in case where the concentration of the monomer component is more than 80 weight %, it is difficult to control the polymerization, and liquid-absorbent resins having excellent absorption capacity may not be obtained.

When the crosslinked (co)polymer is obtained, the following methods can be employed: a method which involves polymerizing in the presence of a crosslinking agent, and a method which involves crosslinking after polymerization.

When the polymerization is carried out in the presence of the crosslinking agent, the amount of the crosslinking agent as used can fitly be determined according to the polymerization condition or kind of the monomer component, but is in the range of 0.01 to 5 mol %, preferably 0.03 to 1 mol % relative to the monomer component. The amount of the crosslinking agent as used is less than 0.01 mol %, crosslinked liquid-absorbent resins are obtained, and the resultant resins might be dissolved in water. In case where the amount is more than 5 mol %, the broadness of molecular chains is limited unnecessarily, and the absorption capacity is decreased.

As to means for starting the polymerization of the monomer component comprising a major proportion of the cyclic N-vinyllactam, the following methods can be employed: a method which involves adding a polymerization initiator; a method which involves irradiating ultraviolet light; a method which involves heating; and a method which involves irradiating light in the presence off a photo-initiator.

Examples of the method that involves crosslinking after polymerization include: (1) a method that involves irradiating a N-vinyl pyrrolidone polymer with ultraviolet light; (2) a method that involves self-crosslinking by heating a N-vinyl pyrrolidone polymer; (3) a method that involves adding a radical generating agent to a N-vinyl pyrrolidone polymer, and thereafter, self-crosslinking by heating them; and (4) a method that involves adding a radical polymerizable crosslinking agent and a radical polymerization initiator to a N-vinyllactam polymer, and thereafter, heating and/or irradiating with light.

The N-vinyl pyrrolidone polymer as used in the methods (1) to (4) can be obtained by polymerizing a monomer component comprising a N-vinyllactam monomer by a conventional polymerization method, such as bulk polymerization method, solution polymerization method, emulsion polymerization, suspension polymerization method, and precipitation polymerization method.

In the method (4), the method for adding the radical polymerization initiator to the N-vinyl pyrrolidone polymer is not especially limited. However, for example, the radical polymerization initiator may be added to a reaction liquid immediately after obtaining the N-vinyllactam polymer, or the N-vinyllactam polymer may be dried instead of the reaction liquid, and used in a form of powder.

The radical polymerization initiator as used in the method (4) is not especially limited if it can generate a radical molecule by heat or light. Among the polymerization initiators as used for obtaining the above N-vinyllactam polymer, photoplymerization initiators such as benzoin ethers can be used in addition to azo compounds, peroxides, and redox initiators. Among these, peroxides are particularly preferable because of producing crosslinked polymers having higher form maintenance. Examples of peroxides except for examples mentioned above include: t-butyl peroxypyvalate, octanoyl peroxide, succinic peroxide, t-hexylperoxy-2-ethylhexanoate, t-butyl peroxyisobutyrate, and t-butyl peroxymaleic acid. However, the peroxides are not limited thereto. The amount of the radical polymerization initiator as used is not especially limited, but is preferably in the range of 0.005 to 20 weight %, more preferably 0.05 to 5 weight %, of the total of the N-vinyllactam polymer and the radical polymerizable crosslinking agent.

The radical polymerizable crosslinking agent as used in the method (4) may be a compound having two or more ethylenically unsaturated group per molecule and its molecular weight and molecular structure except for the unsaturated group are not limited. Examples of the radical polymerizable crosslinking agent include: (meth)acrylic crosslinking agents, such as ethylene glycol di(meth)acrylate, polyethylene glycol di(meth)acrylate, trimethylolpropane tri(meth)acrylate, neopentyl glycol di(meth)acrylate, 1,6-hexanediol di(meth)acrylate, pentaerythritol penta(meth)acrylate, dipentaerythritol hexa(meth)acrylate, and ally (meth)acrylate; (meth)acrylamide crosslinking agents, such as N,N′-methylenebisacrylamide; vinyl crosslinking agents, such as N,N′-divinyl-2-imidazolidinone, N,N′-1,4-butylenebis(N-vinylacetamide), divinylbenzene, and divinyltoluene; allyl crosslinking agents, such as diallylamine, triallylamine, tetraallyoxyethane, triallyl cyanurate, triallyl isocyanurate, diallyl ether, ethylene glycol diallyl ether, polyethylene glycol diallyl ether, trimethylolpropane trially ether, allyl sulfide, allyl disulfide, diallyl urea, and dially diesters of polybasic acids (for example, triallyl trimellitate, diallyldimethyl ammonium chloride, sodium diallyloxalate, diallyl phthalate and dially succinate). Among these crosslinking agents, (meth)acrylic and (meth)acrylamide crosslinking agents are preferable because they are favorably reactive to the vinyllactam polymer.

When the N-vinyllactam polymer is crosslinked by the methods (1) to (4), the composition may optionally comprise a solvent. Solvents usable for obtaining the N-vinyllactam polymer can be used as the solvent herein. However, solvents to form uniform dissolved state can preferably be used. The crosslinked polymer obtained from the composition according to the present invention can absorb liquids having a wide pH range. Therefore, the kind and amount of acid or base is not limited in the solvent.

When the crosslinking is carried out with UV or light irradiation in the methods (1) and (4), photopolymerization initiators or sensitizers may be used.

When the N-vinyllactam polymer is crosslinked by the methods (1) to (4), the following additives may be blended with the N-vinyllactam polymer if necessary: mono functional monomers, coloring matters, aromatic agents, fillers, buffer agents, and inorganic salts.

As to the method (2) in detail, the resultant product is obtained by heating the N-vinyllactam polymer with an oven by conventional methods.

The heating condition is not especially limited. However, for example, the heating is preferably carried out at a temperature of 150 to 250° C. for 1 to 120 minutes. In case where the temperature is too higher or the heating time is too longer, the resultant resin may be colored. On the other hand, in case where the temperature is too lower or the heating time is too shorter, the self-crosslinking is difficult to go on and the crosslinking may be insufficient.

As to the method (3) in detail, the resultant product is obtained by adding the radical generating agent to the N-vinyllactam polymer, and thereafter, heating with an oven by conventional methods.

The radical generating agent as used in the method (3) is not especially limited if it is a compound that can generate a radical. Examples thereof include persulfic acid salts, such as potassium persulfate and ammonium persulfate; peroxides, such as alkyl peroxides and peroxy ketals; and azo compounds, such as azobisisobutyronitrile.

The heating condition is not especially limited. However, for example, the heating is preferably carried out at a temperature of 120 to 280° C. for 1 to 30 minutes. In case where the temperature is too higher or the heating time is too longer, the resultant resin may be colored. On the other hand, in case where the temperature is too lower or the heating time is too shorter, the self-crosslinking is difficult to go on and the crosslinking may be insufficient.

The extractable content in the crosslinked (co)polymer is preferably not more than 30 weight %, more preferably not more than 20 weight %. In case where the extractable content is more than 30 weight %, the extractable content is dissolved in deliquescence, and the absorption capacity might gradually be decreased.

The crosslinked (co)polymer as obtained in the above way displays excellent absorption capacity for an aqueous concentrated multivalent metal salt solution, such as an absorption capacity of not less than 20 g/g for an aqueous saturated calcium chloride solution at 25° C.

The hygroscopic composition, which comprises the liquid-absorbent resin and the solid deliquescent substance, has excellent hygroscopic capacity, and does not liquefy even if the composition absorbs moisture.

The production process for a hygroscopic agent, according to the present invention, comprises the steps of: arranging the solid deliquescent substance and the liquid-absorbent resin so that when the solid deliquescent substance has absorbed moisture and deliquesced to liquefy, the resultant liquid can come into contact with the liquid-absorbent resin, wherein: the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

Examples of the solid deliquescent substance and the liquid-absorbent resin as used in the production process for a hygroscopic agent according to the present invention include the same as comprised in the above hygroscopic composition, wherein the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

When the solid deliquescent substance has absorbed moisture and deliquesced to liquefy, it is necessary to arrange the deliquescent substance so that the resultant liquid can come into contact with the liquid-absorbent resin.

The hygroscopic agent, according to the present invention, comprises the liquid-absorbent resin and the solid deliquescent substance, wherein the liquid-absorbent resin is blended with the solid deliquescent substance, and the resultant mixture is wrapped with a wrapping film, and wherein the liquid-absorbent resin is a crosslinked polymer obtained by polymerizing a monomer component comprising a major proportion of a cyclic N-vinyllactam, displays an absorption capacity of not less than 20 g/g for an aqueous saturated calcium chloride solution at 25° C.

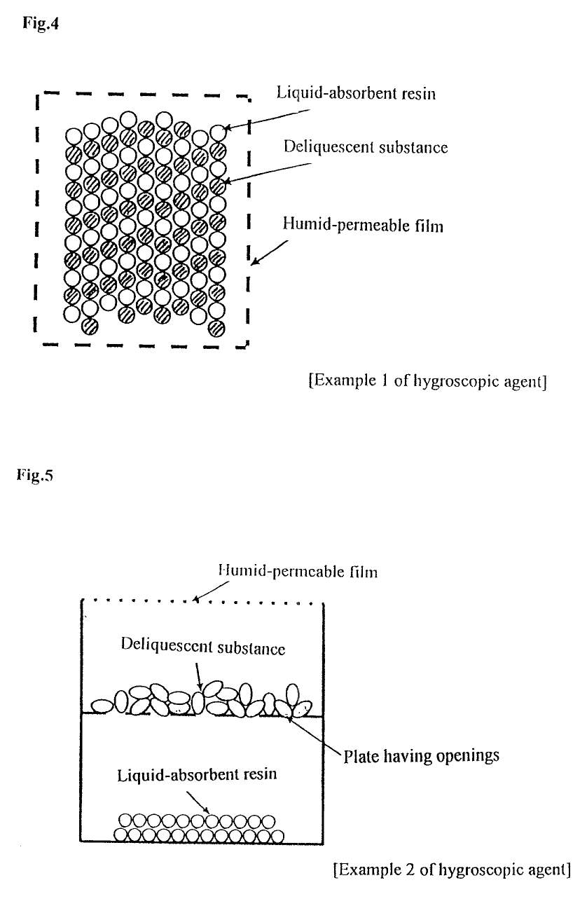

As to an example of the production process for a hygroscopic agent according to the present invention, the hygroscopic composition is wrapped with a humidity-permeable film, wherein the hygroscopic composition is obtained by blending the solid deliquescent substance with the liquid-absorbent resin, which is a crosslinked polymer obtained by polymerizing a monomer component comprising a major proportion of a cyclic N-vinyllactam, and displays an absorption capacity of not less than 20 g/g for an aqueous saturated calcium chloride solution at 25° C. The figure representing this production process was shown in FIG. 4 as Example 1 of hygroscopic agent.

In addition, another hygroscopic agent, according to the present invention, comprises a liquid-absorbent resin and a solid deliquescent substance, wherein the solid deliquescent substance is arranged so that when the solid deliquescent substance has absorbed moisture and deliquesced to liquefy, the resultant liquid can come into contact with the liquid-absorbent resin, and wherein the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

In addition, as to another example of the production process for a hygroscopic agent according to the present invention, the liquid-absorbent resin is added to a vessel. Thereafter, a plate having openings is placed, and the solid deliquescent substance is arranged on the plate having openings. Then, the vessel is covered with a humidity-permeable film. In this way, the solid deliquescent substance and the liquid-absorbent resin are arranged, thus obtaining a hygroscopic agent. In the above way, when the deliquescent substance deliquesces and is liquefied, the resultant deliquescence is dropped away from the plate having openings and comes in contact with the liquid-absorbent resin, so that the liquid-absorbent resin inhibits the liquefaction by absorbing and gelling the deliquescence. In addition, when the above state is kept, the entirety of the deliquescent substance on the plate having openings is lost, and then it would be understood that the hygroscopic capacity is lost. The figure representing this production process was shown in FIG. 5 as Example 2 of hygroscopic agent.

(Effects and Advantages of the Invention):

The present invention can provide the hygroscopic composition comprising the deliquescent substance that has highly hygroscopic capacity but is deliquescent, and having excellent deliquescence-retaining capacity, which is caused by the liquid-absorbent resin enabling to highly absorb the resultant deliquescence.

The present invention can provide: the hygroscopic agent, not only having excellent deliquescence-retaining capacity, which is caused by the liquid-absorbent resin enabling to highly absorb deliquescence formed by absorbing moisture and deliquescing, but also enabling users to confirm with their eyes that the deliquescent substance absorbs moisture and deliquesces, namely, that the deliquescent substance does not have dehumidifying capacity any longer; and the production process therefor.

### DETAILED DESCRIPTION OF THE PREFERRED EMBODIMENTS

Hereinafter, the present invention is more specifically illustrated by the following examples of some preferred embodiments. However the present invention is not limited to these examples.

### PRODUCTION EXAMPLE 1

At first, 150.07 parts by weight of N-vinyl-2-pyrrolidone (Mw: 111.1), 0.168 parts by weight of triallyl cyanurate (Mw: 249.27, reagent made by Wako Pure Chemicals Co., Ltd.), and 346.58 parts by weight of deionized water were added to a separable flask having a capacity of 500 ml in order to blend them, thus preparing an aqueous monomer component solution. In the above aqueous solution, the amount of N-vinyl-2-pyrrolidone as included was 100 mol % of the monomer component, the concentration of the monomer component was 30 weight %, and the amount of a crosslinking agent, namely, triallyl cyanurate as included was 0.05 mol % of the monomer component.

Nitrogen gas was bubbled into this aqueous solution, and the dissolved oxygen in the aqueous solution was decreased to not more than 0.1 ppm. Next, the flask was put in a water bath so that the temperature of the aqueous solution would be adjusted to 50° C. Next, 3.38 parts by weight of an aqueous 2,2′-azobis(2-amidinopropane) dihydrochloride solution of 10 weight % (V-50, made by Wako Pure Chemicals Co., Ltd.) was added thereto as a polymerization initiator, and the resultant mixture was stirred for 30 seconds. Thereafter, the stirring was stopped and the resultant mixture was left still. When three minutes passed from adding the polymerization inhibitor, the polymerization started, and when 35 minutes passed, the polymerization reached the peak. Then, the temperature was 100° C. The aging reaction was carried out for 20 minutes after the peak, and thereafter, the resultant polymerized gel was taken from the flask. The gel was transparent.

This gel was cut into pieces having a size of about W3×D3×H3 mm with scissors, and dried with a hot blow (in Perfect oven PS-112, made by Tabaiespec Co., Ltd.) at 120° C. for 3 hours. After drying, a yellow-white resin was obtained. Then, this resin was pulverized with a desk-type small-sized pulverizer (Sample mill SK-M10, made by Kyoritsuriko Co., Ltd.) and classified with respective sieves having mesh openings of 1,000 μm and 500 μm, thus obtaining a liquid-absorbent resin (1) having a particle diameter which passed through the sieve of 1,000 μm and remained on the sieve of 500 μm.

### PRODUCTION EXAMPLE 2

A flask in a capacity of 1 liter with a stirring blade, a monomer supplying tank, a thermometer, a reflux condenser, and a nitrogen introducing tube was charged with 800 g of water, and they were heated so that the internal temperature would be adjusted to 75° C. while nitrogen gas was introduced and while being stirred. To this flask, 200 g of N-vinyl pyrrolidone and 0.06 g of 2,2′-azobis(2-amidinopropane)dihydrochloride were supplied over a period of 60 minutes to carry out polymerization. After heating for two hours at the same temperature, the internal temperature was elevated to 90° C., and the heating was further continued for 30 minutes to complete the polymerization, thus obtaining an aqueous polyvinyl pyrrolidone solution. The non-volatile content of the aqueous polyvinyl pyrrolidone solution as obtained was 19.9%.

The aqueous polyvinyl pyrrolidone solution as obtained was dried at 120° C. for one hour, and further pulverized, thus obtaining a polyvinyl pyrrolidone powder.

The polyvinyl pyrrolidone powder as obtained was put into a hot-air dryer, and heat-treated at 200° C. for 30 minutes, thus obtaining a liquid-absorbent resin (2).

### PRODUCTION EXAMPLE 3

The polyvinyl pyrrolidone powder as obtained in Production Example 2 was put into a hot-air dryer, and heat-treated at 180° C. for 120 minutes, thus obtaining a liquid-absorbent resin (3).

### COMPARATIVE PRODUCTION EXAMPLE 1

At first, 177.6 parts by weight of aqueous acrylamide solution of 40 weight % (Mw: 71.04, made by Mitsui Toatsu Chemical Co., Ltd.), 5.14 parts by weight of aqueous N,N′-methylenebisacrylamide solution of 1.5 weight % (Mw: 154.17, TRIAM-507 made by Wako Pure Chemicals Co., Ltd.), and 97.42 parts by weight of deionized water were added to a separable flask having a capacity of 500 ml in order to blend them, thus preparing an aqueous monomer component solution. In the above aqueous solution, the amount of acrylamide as included was 100 mol % of the monomer component, the concentration of the monomer component was 25 weight %, and the amount of a crosslinking agent, namely, N,N′-methylenebisacrylamide as included was 0.05 mol % of the monomer component.

Nitrogen gas was bubbled into this aqueous solution, and the dissolved oxygen in the aqueous solution was decreased to not more than 0.1 ppm. Next, the flask was put in a water bath so that the temperature of the aqueous solution would be adjusted to 25° C. Next, 2.0 parts by weight of an aqueous sodium persulfate solution of 10 weight % (reagent, made by Katayama Chemicals Co., Ltd.) was added thereto as a polymerization initiator. Then, 2.0 parts by weight of aqueous L-ascorbic acid solution of 1 weight % (reagent, made by Wako Pure Chemicals Co., Ltd.) was further added thereto, and the resultant mixture was stirred for 30 seconds. Thereafter, the stirring was stopped and the resultant mixture was left still. When ten minutes passed from adding the aqueous L-ascorbic acid solution, the polymerization started, and when 44 minutes passed, the polymerization reached the peak. Then, the temperature was 85.5° C. The aging reaction was carried out for 20 minutes after the peak, and thereafter, the resultant polymerized gel was taken from the flask. The gel was transparent.

This gel was cut into pieces having a size of about W3×D3×H3 mm with scissors, and dried with a hot blow (in Perfect oven PS-112, made by Tabaiespec Co., Ltd.) at 120° C. for 3 hours. After drying, a yellow-white resin was obtained. Then, this resin was pulverized with a desk-type small-sized pulverizer (Sample mill SK-M10, made by Kyoritsuriko Co., Ltd.) and classified with respective sieves having mesh openings of 1,000 μm and 500 μm, thus obtaining a comparative liquid-absorbent resin (1) having a particle diameter which passed through the sieve of 1,000 μm and remained on the sieve of 500 μm.

### COMPARATIVE PRODUCTION EXAMPLE 2

At first, 124.3 parts by weight of aqueous acrylamide solution of 40 weight % (Mw: 71.04, made by Mitsui Toatsu Chemical Co., Ltd.), 21.6 parts by weight of acrylic acid of 100% (Mw: 72.06, made by Nippon Shokubai Co., Ltd.), 25.0 parts by weight of aqueous sodium hydroxide solution of 48 weight % (Mw: 40.0, made by Kaname Chemicals Co., Ltd.), 10.28 parts by weight of aqueous N,N′-methylenebisacrylamide solution of 1.5 weight % (Mw: 154.17, TRIAM-507 made by Wako Pure Chemicals Co., Ltd.), and 74.59 parts by weight of deionized water were added to a separable flask having a capacity of 500 ml in order to blend them, thus preparing an aqueous monomer component solution. In the above aqueous solution, the amount of acrylamide and sodium acrylate as included was 70 mol % and 30 mol % of the monomer component respectively, the concentration of the monomer component was 30 weight %, and the amount of a crosslinking agent, namely, N,N′-methylenebisacrylamide as included was 0.1 mol % of the monomer component.

Nitrogen gas was bubbled into this aqueous solution, and the dissolved oxygen in the aqueous solution was decreased to not more than 0.1 ppm. Next, the flask was put in a water bath so that the temperature of the aqueous solution would be adjusted to 20° C. Next, 2.0 parts by weight of an aqueous sodium persulfate solution of 10 weight % (reagent, made by Katayama Chemicals Co., Ltd.) was added thereto as a polymerization initiator. Then, 2.0 parts by weight of aqueous L-ascorbic acid solution of 1 weight % (reagent, made by Wako Pure Chemicals Co., Ltd.) was further added thereto, and the resultant mixture was stirred for 30 seconds. Thereafter, the stirring was stopped and the resultant mixture was left still. When three minutes passed from adding the aqueous L-ascorbic acid solution, the polymerization started, and when 44 minutes passed, the polymerization reached the peak. Then, the temperature was 100° C. The aging reaction was carried out for 20 minutes after the peak, and thereafter, the resultant polymerized gel was taken from the flask. The gel was transparent.

This gel was cut into pieces having a size of about W3×D3×H3 mm with scissors, and dried with a hot blow (in Perfect oven PS-112, made by Tabaiespec Co., Ltd.) at 160° C. for 3 hours. After drying, a yellow-white resin was obtained. Then, this resin was pulverized with a desk-type small-sized pulverizer (Sample mill SK-M10, made by Kyoritsuriko Co., Ltd.) and classified with respective sieves having mesh openings of 1,000 μm and 500 μm, thus obtaining a comparative liquid-absorbent resin (2) having a particle diameter which passed through the sieve of 1,000 μm and remained on the sieve of 500 μm.

### COMPARATIVE PRODUCTION EXAMPLE 3

A flask in a capacity of 1 liter with a stirring blade, a monomer supplying tank, a thermometer, a reflux condenser, and a nitrogen introducing tube was charged with 800 g of water, and they were heated so that the internal temperature would be adjusted to 75° C. while nitrogen gas was introduced and while being stirred. To this flask, 200 g of N-vinyl pyrrolidone and 0.06 g of 2,2′-azobis(2-amidinopropane)dihydrochloride were supplied over a period of 60 minutes to carry out polymerization. After heating for two hours at the same temperature, the internal temperature was elevated to 90° C., and the heating was further continued for 30 minutes to complete the polymerization, thus obtaining an aqueous polyvinyl pyrrolidone solution. The non-volatile content of the aqueous polyvinyl pyrrolidone solution as obtained was 19.9%.

The aqueous polyvinyl pyrrolidone solution as obtained was dried at 120° C. for one hour, and further pulverized, thus obtaining a polyvinyl pyrrolidone powder.

The polyvinyl pyrrolidone powder as obtained was put into a hot-air dryer, and heat-treated at 200° C. for 60 minutes, thus obtaining a comparative liquid-absorbent resin (5).

### COMPARATIVE PRODUCTION EXAMPLE 4

The polyvinyl pyrrolidone powder as obtained in Comparative Production Example 3 was put into a hot-air dryer, and heat-treated at 190° C. for 120 minutes, thus obtaining a comparative liquid-absorbent resin (6).

[Measurement Method of Absorption Capacity]

(Preparation of Aqueous Saturated Calcium Chloride Solution (Liquid to be Absorbed)):

While being cooled, 120 g of anhydrous calcium chloride and 137.5 g of deionized water were added, and the resultant mixture was stirred and dissolved. The temperature of the resultant aqueous solution was adjusted to 25° C., and the aqueous solution was stirred for three hours. The supernatant solution of the aqueous solution was used as a liquid to be absorbed because a small amount of calcium chloride was not dissolved and remained.

(Operation of Absorbing Liquid):

Two pieces of heat-sealable nonwoven cloth having a square of 5 cm were prepared. After the two pieces were piled up, the portion at 1 mm's distance from the edge was heat-sealed, and three sides among four sides were adhered to prepare a bag. After 0.3 g of liquid-absorbent resin was put therein, the last side was heat-sealed so that the liquid-absorbent resin would not be scattered.

To a polypropylene vessel having an internal diameter of 6 cm and a depth of 10 cm, the aqueous saturated calcium chloride solution as prepared was added. Then, the bag including the liquid-absorbent resin was immersed therein. A stirrer chip was put therein, and the vessel was sealed. The resultant immersed bag including the liquid-absorbent resin was drawn up after being stirred for five hours.

(Operation of Draining):

Two pieces of kitchen towel (made by Oji Seishi) were cut off, and were respectively folded four times to adjust their sizes of 6 cm×6 cm. One piece of them was put on a table, and the immersed bag including the liquid-absorbent resin as drawn up was put thereon, and further, another piece of folded kitchen towel was put thereon. Then, a weight of 20 g/cm² was put thereon, and the bag was drained for 20 seconds. After being drained, the weight (W1 g) of the bag including the liquid-absorbent resin was measured. The same procedure as the above was carried out using no liquid-absorbent resin as blank test, and weight (W2 g) of the resultant bag was measured.

Absorption capacity (g/g)=(W1(g)−weight W2(g))/0.3(g).

[Evaluation Method 1 of Hygroscopic State]

As is shown in FIG. 1, a beaker (vessel 2), including a hygroscopic composition obtained by blending 1 part by weight of a liquid-absorbent resin and 9 parts by weight of calcium chloride, was put in a vessel (vessel 1) including water, and was covered with a lid to seal off. Then, the beaker was put in a thermoregulator adjusted at a temperature of 25° C.

The state of the hygroscopic composition was observed every predetermined time.

[Evaluation Method 2 of Hygroscopic State]

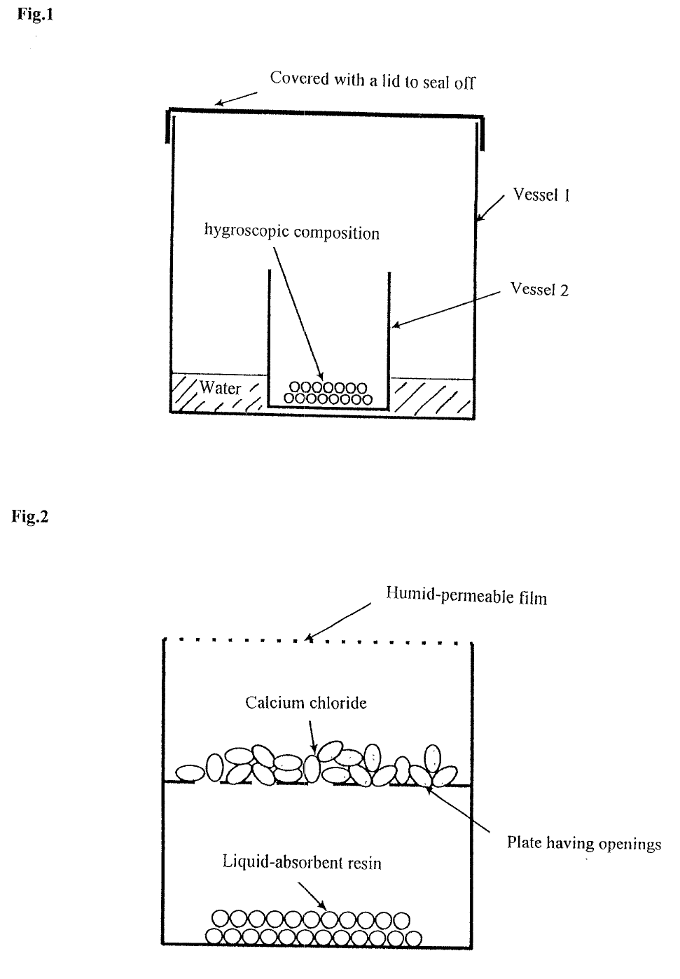

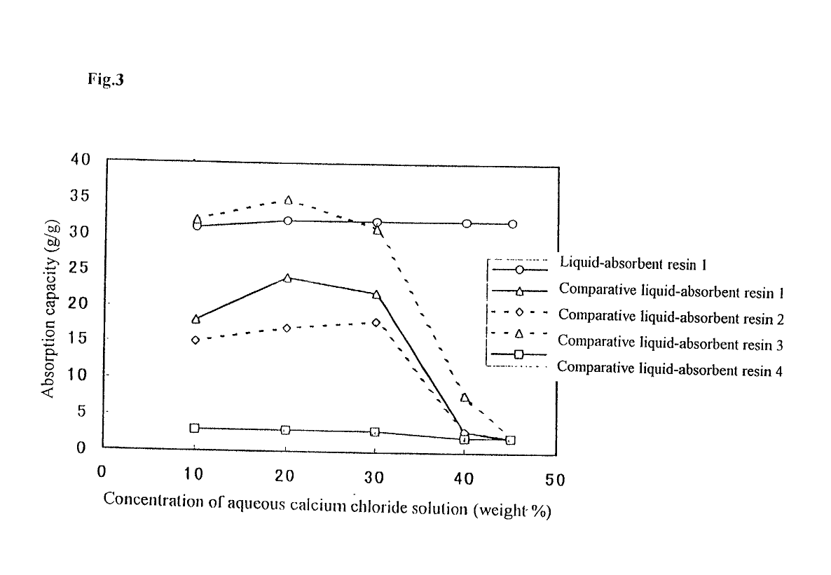

As is shown in FIG. 2, 9 parts by weight of calcium chloride and 1 part by weight of a liquid-absorbent resin were put in a vessel. That is to say, after the liquid-absorbent resin was put in the vessel, a plate having openings is placed therein and solid calcium chloride is arranged on the plate having openings. Then, the vessel was covered with a humidity-permeable film. This vessel was put in a thermoregulator adjusted at a temperature of 25° C. and a relative humidity of 95%, and the state was observed every predetermined time. The result was listed in Table 3.

[Measurement Method of Liquid-absorbing Rate]

To a beaker having a capacity of 100 ml, 50 g of aqueous calcium chloride solution of 45 weight % and a stirrer chip (length: 4 cm) were added, and 20 g of liquid-absorbent resin was added thereto while being stirred. Then, measured was the time (second) until gel was formed. The result was listed in Referential Table.

### EXAMPLES 1 TO 3

The absorption capacities of the liquid-absorbent resins (1) to (3) as obtained in Production Examples 1 to 3 were measured in aqueous calcium chloride solutions each adjusted to a predetermined concentration. The results were listed in Table 1 and FIG. 3.

As is apparent from these results, the liquid-absorbent resin according to the present invention has particularly excellent absorption capacity for a liquid obtained by absorbing moisture and deliquescing (deliquescent substance), namely, in an area of saturated concentration (45 weight % in this case).

### COMPARATIVE EXAMPLES 1 TO 6

As to the below-mentioned liquid-absorbent resins, the absorption capacities were measured in the same way as of Example 1. The results were listed in Table 1 and FIG. 3.

Comparative liquid-absorbent resin (1): Crosslinked polyacrylamide polymer as obtained in Comparative Production Example 1

Comparative liquid-absorbent resin (2): Crosslinked acrylamide-sodium acrylate copolymer obtained in Comparative Production Example 2

Comparative liquid-absorbent resin (3): Crosslinked N-vinylacetamide polymer (NA-010, made by Showa Denko Co., Ltd.)

Comparative liquid-absorbent resin (4): Crosslinked polyacrylate polymer partially including sodium salt (AQUALIC CA-W4, made by Nippon Shokubai Co., Ltd.)

Comparative liquid-absorbent resin (5): Polyvinyl pyrrolidone post-crosslinked polymer obtained in Comparative Production Example 3

Comparative liquid-absorbent resin (6): Polyvinyl pyrrolidone post-crosslinked polymer obtained in Comparative Production Example 4

### EXAMPLES 4 TO 6

The liquid-absorbent resins (1) to (3) as obtained in Production Examples 1 to 3 were evaluated according to the above Evaluation method 1 of hygroscopic state. The results were listed in Table 2. As is apparent from Table 2, because the liquid-absorbent resin according to the present invention completely absorbed and retained a liquid obtained by absorbing moisture and deliquescing, the resultant deliquescence did not flow at all.

### COMPARATIVE EXAMPLES 7 TO 13

The above comparative liquid-absorbent resins (1) to (6), and a comparative water-soluble resin (1) were evaluated in the same way as of Examples 4 to 6. The results were listed in Table 2.

Comparative water-soluble resin (1): Polyethylene oxide (Mw=200,000)

### EXAMPLES 7 TO 9

The liquid-absorbent resins (1) to (3) as obtained in Production Examples 1 to 3 were evaluated according to the above Evaluation method 2 of hygroscopic state. The result was listed in Table 3. As is apparent from Table 3, because the liquid-absorbent resin according to the present invention completely absorbed and retained a liquid obtained by absorbing moisture and deliquescing, the resultant deliquescence did not flow at all. In addition, as is shown in Referential Table, it would be apparent that its liquid-absorbing rate is faster than that of the comparative liquid-absorbent resins.

### COMPARATIVE EXAMPLES 14 TO 20

The comparative liquid-absorbent resins (1) to (6), and the comparative water-soluble resin (1) were evaluated in the same way as of Examples 7 to 9. The results were listed in Table 3.

TABLE 1
Measured results of absorption capacity of each liquid-absorbent resin
in each concentration of aqueous calcium chloride solution

| | | Concentration of aqueous | | | | |
|---|---|---|---|---|---|---|
| | | calcium chloride solution | | | | |
| | | (wt %) | | | | |
| | | 10 | 20 | 30 | 40 | 45 |
| | Liquid-absorbent resin | Absorption capacity (g/g) | | | | |
| Example 1 | Liquid-absorbent resin (1) | 31 | 32 | 32 | 32 | 32 |
| Example 2 | Liquid-absorbent resin (2) | 21 | 21 | 20 | 20 | 20 |
| Example 3 | Liquid-absorbent resin (3) | 23 | 22 | 21 | 21 | 22 |
| Comparative | Comparative | 18 | 24 | 32 | 3 | 2 |
| Example 1 | liquid-absorbent resin (1) | | | | | |
| Comparative | Comparative | 15 | 17 | 22 | 3 | 2 |
| Example 2 | liquid-absorbent resin (2) | | | | | |
| Comparative | Comparative | 32 | 35 | 31 | 8 | 2 |
| Example 3 | liquid-absorbent resin (3) | | | | | |
| Comparative | Comparative | 3 | 3 | 3 | 2 | 2 |
| Example 4 | liquid-absorbent resin (4) | | | | | |
| Comparative | Comparative | 8 | 8 | 8 | 8 | 8 |
| Example 5 | liquid-absorbent resin (5) | | | | | |
| Comparative | Comparative | 9 | 9 | 9 | 9 | 9 |
| Example 6 | liquid-absorbent resin (6) | | | | | |

TABLE 2
Results of Evaulation method 1 of hygroscopic state

| | | Result as | |
|---|---|---|---|
| | Liquid-absorbent resin | evaluated | Explanation of state |
| Example 2 | Liquid-absorbent resin (1) | ◯ | No fluidity, and all gelled. |
| Example 3 | Liquid-absorbent resin (2) | ◯ | No fluidity, and all gelled. |
| Example 4 | Liquid-absorbent resin (3) | ◯ | No fluidity, and all gelled. |
| Comparative | Comparative | X | Resins were not swollen at all, and dispersed in |
| Example 7 | liquid-absorbent resin (1) | | deliquescence. |
| Comparative | Comparative | X | Resins were not swollen at all, and dispersed in |
| Example 8 | liquid-absorbent resin (2) | | deliquescence. |
| Comparative | Comparative | X | Resins were not swollen at all, and dispersed in |
| Example 9 | liquid-absorbent resin (3) | | deliquescence. |
| Comparative | Comparative | X | Resins were not swollen at all, and dispersed in |
| Example 10 | liquid-absorbent resin (4) | | deliquescence. |
| Comparative | Comparative | X | Resins were not swollen at all, and dispersed in |
| Example 11 | liquid-absorbent resin (5) | | deliquescence. |
| Comparative | Comparative | X | Resins were not swollen at all, and dispersed in |
| Example 12 | liquid-absorbent resin (6) | | deliquescence. |
| Comparative | Comparative | X | Resins were not swollen at all, and dispersed in |
| Example 13 | water-soluble resin (1) | | deliquescence. |

TABLE 3
Results of Evaluation method 2 of hygroscopic state

| | | Result as | |
|---|---|---|---|
| | Liquid-absorbent resin | evaluated | Explanation of state |
| Example 7 | Liquid-absorbent resin (1) | ◯ | No fluidity, and all gelled. |
| Example 8 | Liquid-absorbent resin (2) | ◯ | No fluidity, and all gelled. |
| Example 9 | Liquid-absorbent resin (3) | ◯ | No fluidity, and all gelled. |
| Comparative | Comparative | X | Resins were not swollen at all, and dispersed in |
| Example 14 | liquid-absorbent resin (1) | | deliquescence. |
| Comparative | Comparative | X | Resins were not swollen at all, and dispersed in |
| Example 15 | liquid-absorbent resin (2) | | deliquescence. |
| Comparative | Comparative | X | Resins were not swollen at all, and dispersed in |
| Example 16 | liquid-absorbent resin (3) | | deliquescence. |
| Comparative | Comparative | X | Resins were not swollen at all, and dispersed in |
| Example 17 | liquid-absorbent resin (4) | | deliquescence. |
| Comparative | Comparative | X | Resins were not swollen at all, and dispersed in |
| Example 18 | liquid-absorbent resin (5) | | deliquescence. |
| Comparative | Comparative | X | Resins were not swollen at all, and dispersed in |
| Example 19 | liquid-absorbent resin (6) | | deliquescence. |
| Comparative | Comparative | X | Resins were not swollen at all, and dispersed in |
| Example 20 | water-soluble resin (1) | | deliquescence. |

TABLE 4
Measured results of liquid-absorbing rate

| | Liquid-absorbing rate |
|---|---|
| | (second) |
| Liquid-absorbing resin (1) | 600 |
| Comparative | >600 |
| liquid-absorbent resin (1) | |
| Comparative | >600 |
| liquid-absorbent resin (2) | |
| Comparative | >600 |
| liquid-absorbent resin (3) | |
| Comparative | >600 |
| liquid-absorbent resin (4) | |

Various details of the invention may be changed without departing from its spirit not its scope. Furthermore, the foregoing description of the preferred embodiments according to the present invention is provided for the purpose of illustration only, and not for the purpose of limiting the invention as defined by the appended claims and their equivalents.

What is claimed is:

1. A hygroscopic composition, which comprises a liquid-absorbent resin and a solid deliquescent substance, wherein the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.

2. A hygroscopic composition according to claim 1, wherein the amount of the solid deliquescent substance per 1 part by weight of the liquid-absorbent is not larger than the amount calculated by the following equation (1):
Weight of deliquescent substance (part by weight)=Concentration of deliquescent substance in deliquescence (weight %)×Absorption capacity of liquid-absorbent resin (g/g) Equation (1)

3. A hygroscopic composition according to claim 1, wherein the cyclic N-vinyllactam is N-vinyl-2-pyrrolidone.

4. A hygroscopic composition according to claim 2, wherein the cyclic N-vinyllactam is N-vinyl-2-pyrrolidone.

5. A hygroscopic agent, which comprises a liquid-absorbent resin and a solid deliquescent substance, wherein:
the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C., and is blended with the solid deliquescent substance; and the resultant mixture is wrapped with a wrapping film of which at least a portion comprises a humidity-permeable film.

6. A production process for a hygroscopic agent comprising a liquid-absorbent resin and a solid deliquescent substance, wherein:
the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.; and the production process comprises the steps of: blending the liquid-absorbent resin and the solid deliquescent substance; and wrapping the resultant mixture with a wrapping film of which at least a portion comprises a humidity-permeable film.

7. A hygroscopic agent, which comprises a liquid-absorbent resin and a solid deliquescent substance, wherein:
the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.; and the solid deliquescent substance is arranged so that when the solid deliquescent substance has absorbed moisture and deliquesced to liquefy, the resultant liquid can come into contact with the liquid-absorbent resin.

8. A production process for a hygroscopic agent comprising a liquid-absorbent resin and a solid deliquescent substance, wherein:
the liquid-absorbent resin is a crosslinked polymer obtained by polymerizing a monomer component comprising a major proportion of a cyclic N-vinyllactam, and displays an absorption capacity of not less than 20 g/g for an aqueous saturated calcium chloride solution at 25° C.; and the production process comprises the step of: arranging the solid deliquescent substance so that when the solid deliquescent substance has absorbed moisture and deliquesced to liquefy, the resultant liquid can come into contact with the liquid-absorbent resin.
